(19) United States
(12) Patent Application Publication
(10) Pub. No.: US 2004/0073793 A1
(43) Pub. Date: Apr. 15, 2004

(54) Network system, information processing device, repeater, and method of building network system

(75) Inventor: Jun Takeda, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/666,341

(22) Filed: Sep. 22, 2003

(30) Foreign Application Priority Data
Oct. 10, 2002 (JP) 2002-297550

(51) Int. Cl. H04L 9/00

(52) U.S. Cl. 713/168; 713/201

(57) ABSTRACT

An access point (AP), upon receipt of a request to commence authentication from a station (STA), obtains supplicant identification information (EAP-Response/Identity) from the station (STA) and refers to a rule table (RT) to thereby identify a RADIUS server that is to authenticate the access point (AP).

### CROSS-REFERENCE TO RELATED APPLICATIONS

This application is based upon and claims the benefit of priority from the prior Japanese Patent Application No. 2002-297550, filed Oct. 10, 2002, the entire contents of which are incorporated herein by reference.

### BACKGROUND OF THE INVENTION

1. Field of the Invention

The present invention relates to a network system, an information processing device, a repeater and a method of building the network system, which are applied to a network environment in which a high level of authentication procedure is required.

2. Description of the Related Art

To assure sufficient security against unauthorized access to a network, use is made of equipment for user authentication. As a typical example of user authentication equipment, the RADIUS server is known (see, for example, “Authentication Server Software” by Accense Technology Corp., http://accesnse.com/fullflex).

The IEEE 802.1x is a standard for access control on a port basis (see, for example, IEEE 802.1x-2001 “Port-Based Network Access Control”, Jul. 14, 2001). Specifically, authentication processing is performed on equipment that wants to access a network (equipment connected to a port). Only the equipment that has passed the authentication is granted to access the network (the port is opened).

Ports described herein include physical ones, such as Ethernet LAN cables, and logical ones. For example, with wireless LAN networks, when connection is set up between a station (STA) and an access point (AP), the station (STA) can be considered to have been connected to the port.

IEEE 802.1x defines the following three components:

(1) Supplicant

The component to be authenticated.

(2) Authenticator

The component that controls access by the supplicant. It opens and closes a port.

(3) Authentication Server

The component that performs authentication processing on the supplicant.

However, IEEE 802.1x does not particularly establish detailed regulations pertaining to communications from the authenticator to the authentication server. In a conventional technique, therefore, the authenticator makes communications with prespecified authentication servers in a fixed manner. This supposes that the authentication servers undertake authentication of all the supplicants.

With this conventional technique, reconfiguring supplicants in network environments independent of each other so that a supplicant in one of the network environments is allowed to make access to another network may involve a very high cost.

For example, there are network environments of a domain A and a domain B each of which has an authentication server. In such a case, in order to reconfigure the environment so that a supplicant B that belongs to the domain B can make access to the network of the domain A or a supplicant A that belongs to the domain A can make access to the network of the domain B, it is required to combine the domain A and the domain B into a new one (e.g., a domain C) (a first method) or to build an environment in which the authentication servers in the domains A and B cooperate with each other to undertake authentication (a second method). Here, the cooperation between the authentication servers also includes such a function as RADIUS Proxy.

The first method involves some cost because a new network environment must be built. The second method has an advantage of ease in building a network but includes a cause of instability in the system configuration because not all the authentication servers have a function to allow cooperation.

Thus, the conventional technique has various problems involved in building a system that allows each of the supplicants in two or more environments (for example, domains) to make access to a network through the authenticator in the corresponding environment (domain).

### BRIEF SUMMARY OF THE INVENTION

According to an embodiment of the present invention, a network system comprises a terminal which makes access to a network; a server which, when an access request is made by a terminal, authenticates the requesting terminal; and a processing device which receives an authentication request from a terminal, identifies a server which authenticates the terminal based on information received from the terminal at the time of reception of the request, and connects the requesting terminal to the identified server.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a schematic illustration of a system configuration according to an embodiment of the present invention;

FIG. 2 shows a configuration of the rule table (RT) in the system configuration of FIG. 1;

FIG. 3 is a flowchart for processing by an access point using the rule table (RT) of FIG. 2;

FIG. 4 is a conceptual diagram of the operation of the present invention;

FIG. 5 shows an example of supplicant identification information (EAP-Response/Identity) for explaining the pattern matching operation using the rule table (RT) in FIG. 2; and

FIG. 6 shows the flow of processing at the time of authentication in the embodiment.

### DETAILED DESCRIPTION OF THE INVENTION

An embodiment of the present invention will now be described with reference to the accompanying drawings.

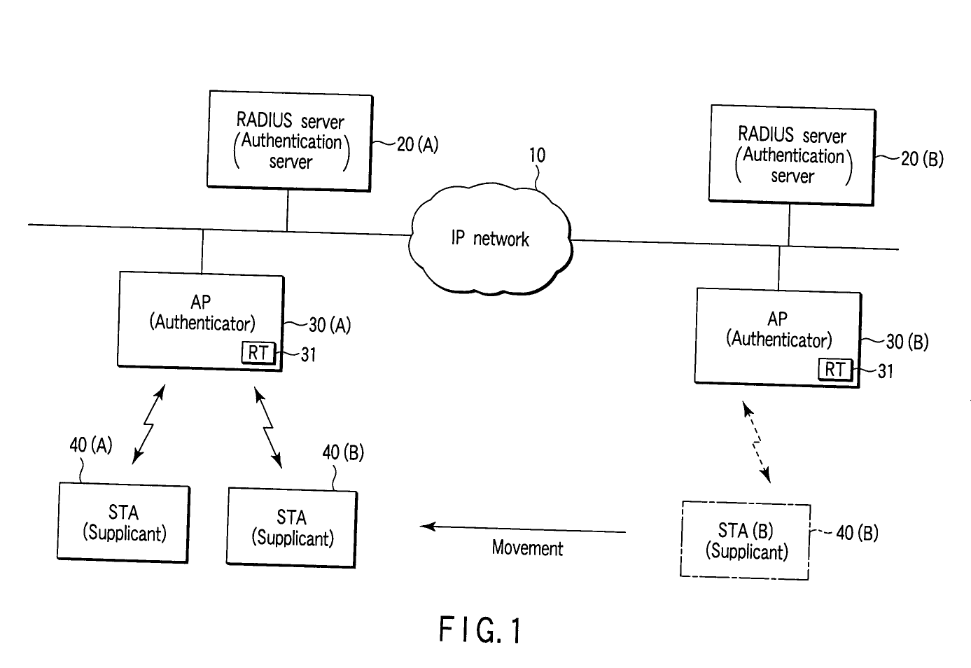

FIG. 1 shows, in block diagram form, a system configuration embodying the present invention. In this example, components (20A, 30A, 40A) in a domain A are network interconnected to components (20B, 30B, 40B) in a domain B through an IP network 10.

The domain A includes a RADIUS server 20(A) serving as an authentication server, an access point (AP) 30(A) as an authenticator, and a station (STA) 40(A) as a supplicant.

The domain B includes a RADIUS server 20(B) serving as an authentication server, an access point (AP) 30(B) as authenticator, and a station (STA) 40(B) as a supplicant. Note that each domain is indicated herein to comprise one authentication server, one authenticator, and one supplicant only for the purpose of simplifying the description. Each of the stations 40(A) and 40(B) is implemented by a general-purpose personal computer and linked to a corresponding one of the access points 30(A) and 30(B) by a wireless LAN.

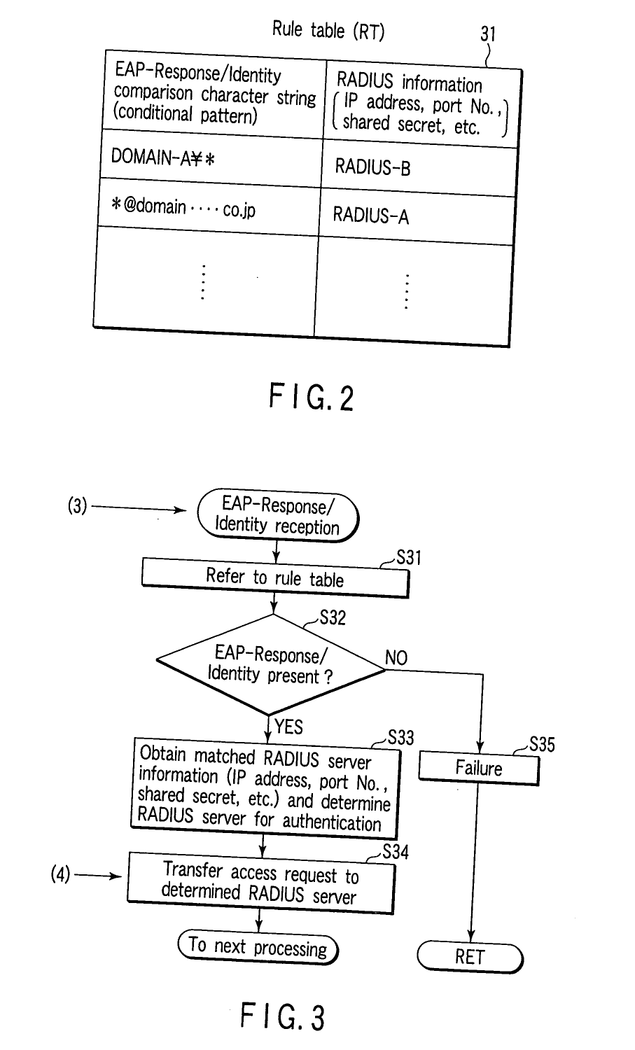

Each of the access points 30(A) and 30(B) has such a rule table (RT) 31 as shown in FIG. 2.

The rule table 31 is used to, when a request for authentication is made by each station, identify a RADIUS server which is to authenticate that server. In the table, as shown in FIG. 2, comparison character strings (conditional patterns) each of which allows the domain to which each of the radius servers 20(A) and 20(B) belongs to be identified and RADIUS information concerning each of these servers which is placed in a respective one of the network connectable domains have been set and entered in a mapped form.

The comparison character strings (conditional patterns) in the rule table 31 are referred to at the time of pattern matching with EAP-Response/Identity (in this embodiment, referred to as supplicant identification information) sent from each of the stations 40(A) and 40(B) for the authentication procedure. The pattern matching will be specifically described later with reference to FIG. 5.

FIG. 3 is a flowchart illustrating the processing by the access points (AP) 30(A) and 30(B) using the rule table (RT) 31, which is carried out at the time of receipt of a request for authentication from a station (STA) 40(A/B).

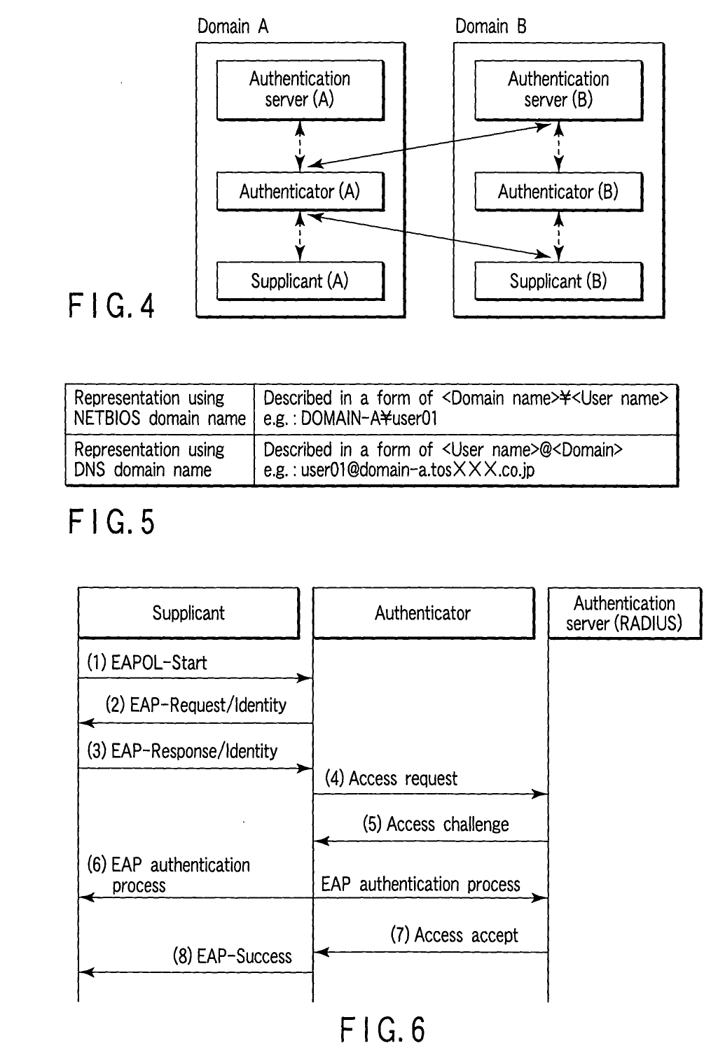

FIG. 4 is a conceptual diagram of the operation of the invention. Here, the route of the authentication procedure between the domains A and B is illustrated with components that conform to the definitions specified in the IEEE 802.1x as objects of processing.

FIG. 5 shows an example of supplicant identification information (EAP-Response/Identity) for explaining the pattern matching operation using the rule table (RT) 31, which is carried out by each of the access points (AP) 30(A) and 30(B) upon receipt of a request for authentication from the station (STA) 40(A/B). Here, the supplicant identification information is described in a form that includes a domain name.

FIG. 6 schematically shows the flow of processing and data at the time of authentication. Here, the components that conform to the definitions specified in the IEEE 802.1x are illustrated as objects of processing. Although, in this example, the RADIUS sever is used as the authentication server, this is not restrictive.

Between (3) and (4) in FIG. 6 the processing of identifying the RADIUS server 20(A/B) shown in FIG. 3 is carried out in accordance with an authentication request.

The operation of the embodiment of the present invention will now be described with reference to FIGS. 1 through 6.

First, the flow of data at the time of authentication will be described with reference to FIG. 6. This demonstrative example is described in terms of the case where the authentication results in success.

(1) EAPOL-Start

A supplicant requests an authenticator to start authentication.

(2) EAP-Request/Identity

The authenticator requests the supplicant to send supplicant identification information (EAP-Response/Identity).

(3) EAP-Response/Identity

The supplicant sends the supplicant identification information (EAP-Response/Identity) to the authenticator.

(4) Access Request

The authenticator requests the authentication server to authenticate the supplicant. The processing shown in FIG. 3 is carried out between (3) and (4).

(5) Access Challenge

A challenge for authentication is returned from the authentication server to the authenticator.

(6) EAP Authentication Process

The process of authentication is carried out between the supplicant and the authentication server. Although, at this point, minute communications are originally made between the supplicant and the authentication server, they are omitted here.

(7) Access Accept

The authentication server notifies the authenticator that the supplicant has been authenticated. If the authentication should fail, then an access rejection message will be sent to the authenticator.

(8) EAP-Success

The authenticator notifies the supplicant that the authentication has succeeded.

The basic operation of the invention will be described below with reference to FIG. 4.

The authenticator A that makes access to a supplicant in the domain A selects the authentication server B that is to authenticate the supplicant B and commences the authentication processing when the supplicant B comes to establish connection with the port (for example, through a wireless LAN). At this point, the authenticator A has to make a decision of which domain the supplicant that has come to establish connection with the port belongs to. For this decision, the supplicant identification information (EAR-Response/Identity) received from the supplicant as shown at (3) in FIG. 6 is used.

The identification name of the supplicant is described in the supplicant identification information (EAR-Response/Identity). How to describe the identification name is not particularly specified. For example, the identification name is described in a form that includes the domain name as shown in FIG. 5.

From the supplicant identification information (EAR-Response/Identity) sent from the supplicant at (3) in FIG. 6, the authenticator determines the domain to which that supplicant belongs. The authenticator then commences communications subsequent to (4) in FIG. 6 with the appropriate authenticator server that belongs to that domain.

Next, the authentication processing in the network system shown in FIG. 1 will be described with reference to FIGS. 1, 2 and 3.

In FIG. 1, the RADIUS server 20(A) authenticates the station (STA) 40(A) which belongs to the domain A and the RADIUS server 20(B) authenticates the station (STA) 40(B) which belongs to the domain B.

The access point (AP) 30(A) controls access by the station (ATA) 40(A) which belongs to the domain A. The access point (AP) 30(B) controls access by the station 40(B) which belongs to the domain B.

The stations (STA) 40(A) and 40(B) establish a connection with the access points (AP) 30(A) and 30(B), respectively, by wireless LANs by way of example. FIG. 1 supposes the case where the station (ATA) 40(B) is comprised of a portable personal computer, the station (ATA) 40 (B) disconnects from the access point (AP) 30(B) of the domain B to which it originally belongs, and makes a request to the access point (AP) 30(A) of the domain A for connection.

At this point, the access point (AP) 30(A) receives a request for authentication (EAP-Start: a request to commence authentication) from the station (STA) 40(B), so that the access point (AP) 30(A) starts data communications for authentication shown in FIG. 6. The access point (AP) 30(A) carries out the process of identifying the RADIUS server that complies with the authentication request shown in FIG. 3 between (3) and (4) in FIG. 6.

This process is performed by referring to the rule table (RT) 31 shown in FIG. 2.

Upon receipt of the request to commence authentication from the station (STA) 40(B) (see (1) in FIG. 6), the access point (AP) 30(A) requests it to send supplicant identification information (EAP-Response/Identity) (see (2) in FIG. 6).

When the access point (AP) 30(A) receives the supplicant identification information (EAP-Response/Identity) from the station (STA) 40(B), the access point (AP) 30(A) searches the RADIUS server 20(A/B) that authenticate the station (STA) 40(B) through pattern matching between comparison character strings in the rule table (RT) 31 shown in FIG. 2 and a part of the identification name (for example, the domain name) shown in FIG. 5 and included in the supplicant identification information (EAP-Response/Identity). That is, the access point (AP) 30(A) searches the same domain name as the requesting station (STA) 40(B) or RADIUS information having a character string structure similar to it (steps S31 and S32 in FIG. 3).

In the presence of the same domain name as the requesting station (STA) 40(B) or RADIUS information having a character string structure similar to it (the presence of a match), the access point (AP) 30(A) determines the RADIUS server 20(B) to which a request for authentication based on the IP address, the port number and so on described in that record of the rule table (RT) 31 where a match was found (step S33 in FIG. 3). The access point (AP) 30(A) send an access request to the determined RADIUS server 20(B) in order to request for authentication.

Such processing allows each of the terminals in different network environments to make access to a different network in their respective environments even if no one reconfigures domains and the authentication servers do not operate cooperatively.

The present invention can be applied to any system that adopts an authentication protocol based on either the IEEE 802.1x or an extensible authentication protocol (EAP) and allows communications between a terminal and an authentication server. For example, the present invention can also be applied to a remote access server (RAS).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A network system comprising:
a terminal which makes access to a network;
a server which, when an access request is made by a terminal, authenticates the requesting terminal; and
a processing device which receives an authentication request from a terminal, identifies a server which authenticates the terminal based on information received from the terminal at the time of reception of the request, and connects the requesting terminal to the identified server.

2. The network system according to claim 1, wherein the server exists for each domain and the terminal exists without being set to the domains.

3. The network system according to claim 1, wherein the processing device, upon receipt of the request from the terminal, identifies a domain to which the requesting terminal belongs and, when the requesting terminal belongs to the domain to which it belongs, performs the process of identifying a server and the process of connecting the requesting terminal to the identified server.

4. The network system according to claim 1, wherein the processing device and the terminal are connected via a wireless LAN.

5. An information processing device comprising:
a receiving unit configured to receive a request for authentication from a terminal which makes access to a network;
an identifying unit configured to identify a device which verifies the eligibility of the requesting terminal to make access to the network based on the received authentication request; and
a connecting unit configured to connect the requesting terminal to the identified device.

6. The information processing device according to claim 5, wherein the identifying unit obtains the identification name of the requesting terminal from information received from the terminal when the authentication request is received, recognizes a domain to which the requesting terminal belongs through a matching operation on the identification name, and identifies the device which verifies the eligibility of the requesting terminal to make access to the network based on the result of the recognition.

7. A repeater for use in a network system having servers each of which authenticates a terminal upon receipt of an access request therefrom, comprising:
an identifying unit configured to identify a server which is to authenticate a requesting terminal, upon reception of a request for authentication from the terminal; and
a connecting unit configured to connect the requesting terminal to the identified server.

8. The repeater according to claim 7, wherein the identifying unit has a table which manages a plurality of network connectable domains and servers each of which is placed in one of the domains in a mapped form and identifies a server which is to authenticate the requesting terminal based on information from the terminal at the time of reception of the request and the table.

9. The repeater according to claim 7, wherein the repeater performs the authentication procedure with the requesting terminal according to the definitions specified in the IEEE 802.1x.

10. The repeater according to claim 7, wherein the repeater performs the authentication procedure with the requesting terminal according to the EAP authentication protocol.

11. A network system comprising:
one supplicant which needs authentication when making access to a network;
authentication server which perform authentication; and
an authenticator which, in response to receipt of a request for authentication from a supplicant, identifies an authentication server which is to authenticate the requesting supplicant and connects the requesting supplicant to the identified authentication server.

12. The network system according to claim 11, wherein the authenticator has a table which manages a plurality of network connectable domains and authentication servers each of which is placed in one of the domains and identifies a server which is to authenticate the requesting terminal by obtaining identification information of the requesting terminal at the time of reception of the request and performing pattern matching between the domain set in the table and the identification information.

13. The network system according to claim 11, wherein the authenticator performs the authentication procedure with the requesting supplicant according to the definitions specified in the IEEE 802.1x.

14. The network system according to claim 11, wherein the authenticator performs the authentication procedure with the requesting supplicant according to the EAP authentication protocol.

15. A method of building a network system having a terminal each of which make access to a network, a repeater which allows a terminal to make access to the network according to an access request from it, and one server, when an access request is made by a terminal, authenticates the requesting terminal,
the allowing the terminal to make access includes receiving an authentication request from a terminal, identifying a server which is to authenticate that terminal based on information received from the terminal, and connecting the requesting terminal to the identified server.

16. The method according to claim 15, wherein the identifying the server identifies a server which is to authenticate the requesting terminal based on a table which manages a plurality of network connectable domains and servers each of which is placed in a respective one of the domains in a mapped form and identification information obtained from the terminal at the time of receipt of the request.
